(19) United States
(12) Patent Application Publication
(10) Pub. No.: US 2026/0284903 A1
(43) Pub. Date: Sep. 24, 2026

(54) SEAL STRUCTURE FOR TORQUE SENSOR AND ROBOT

(71) Applicant: FANUC CORPORATION, Minamitsuru-gun, Yamanashi (JP)

(72) Inventors: Qin Chen TAN, Yamanashi (JP); Yasunobu HATADA, Yamanashi (JP)

(73) Assignee: FANUC CORPORATION, Minamitsuru-gun, Yamanashi (JP)

(21) Appl. No.: 18/879,989

(22) PCT Filed: Aug. 8, 2022
(86) PCT No.: PCT/JP2022/030264

§ 371 Date: Dec. 30, 2024

(51) Int. Cl. B25J 13/08; B25J 19/00; F16J 15/10; G01L 5/00

(52) U.S. Cl. CPC B25J 13/085; B25J 19/0075; F16J 15/10; G01L 5/0061

(57) ABSTRACT

A seal structure for a torque sensor fixed between a first member and a fixed portion of a reducer having a fixed portion and a movable portion rotatably supported with respect to the fixed portion around a predetermined axis line, wherein the torque sensor detects a torque around an axis line and has an annular shape seal member surrounding an outer periphery of the torque sensor, and the seal member is compressed by the fixed portion and the first member in a direction along the axis line.

This application is a national phase of International Application No. PCT/JP2022/030264, filed Aug. 8, 2022, which is incorporated herein by reference in its entirety.

### TECHNICAL FIELD

The present disclosure relates to a support structure of a torque sensor and a robot.

### BACKGROUND ART

Conventionally, there is a known torque detection device in which a seal member is disposed between cases which enclose a torque sensor (see PTL 1, for example). In this device, an annular shape seal member is compressed by one of the cases for housing a reducer and another case for fixing the torque sensor to a position between the other case and an output shaft of the reducer.

### SUMMARY

An aspect of the present disclosure is a seal structure for a torque sensor, the seal structure being fixed to a position between a first member and a fixed portion of a reducer, which includes the fixed portion and a movable portion rotatably supported by the fixed portion around a predetermined axis line, wherein the torque sensor detects a torque around the axis line, wherein the seal structure includes an annular shape seal member surrounding an outer periphery of the torque sensor, and the seal member is compressed by the fixed portion and the first member in a direction along the axis line.

BRIEF DESCRIPTION OF DRAWINGS

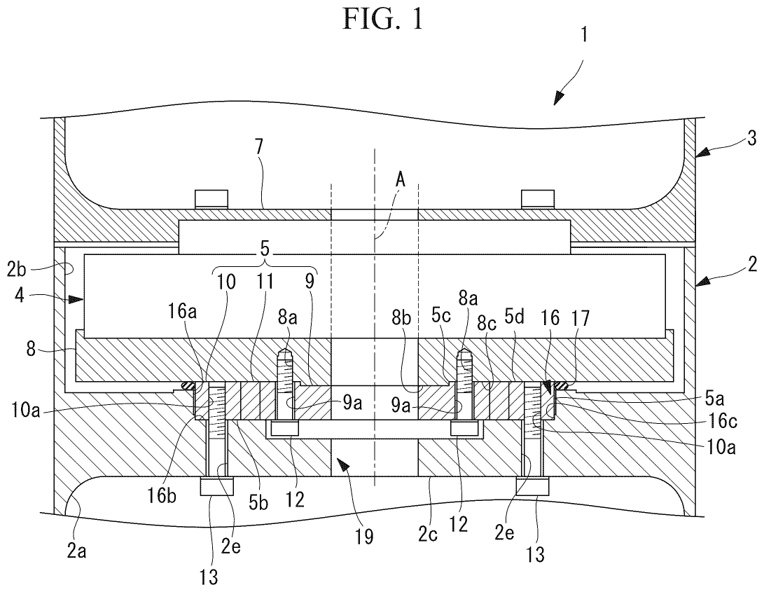

FIG. 1 is a longitudinal cross-sectional view partially showing a robot according to a first embodiment of the present disclosure.

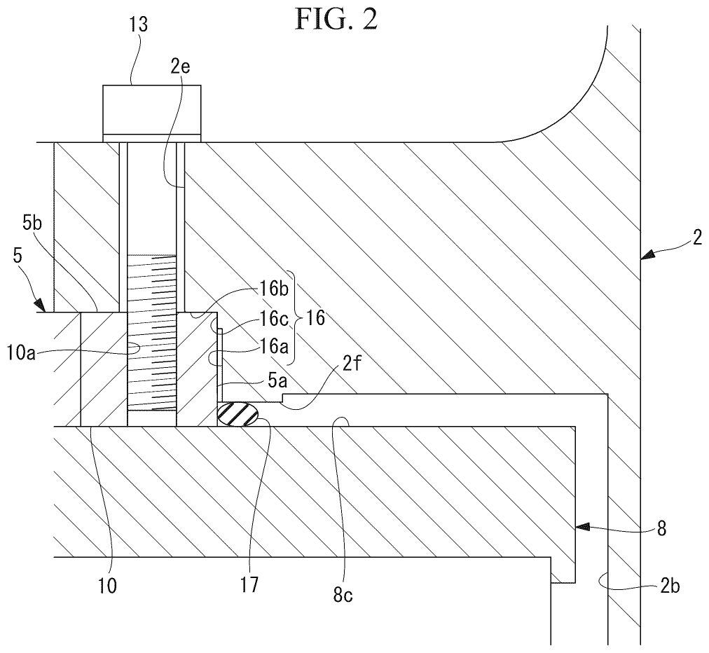

FIG. 2 is an enlarged longitudinal cross-sectional view partially explaining a seal structure of a torque sensor of the robot of FIG. 1.

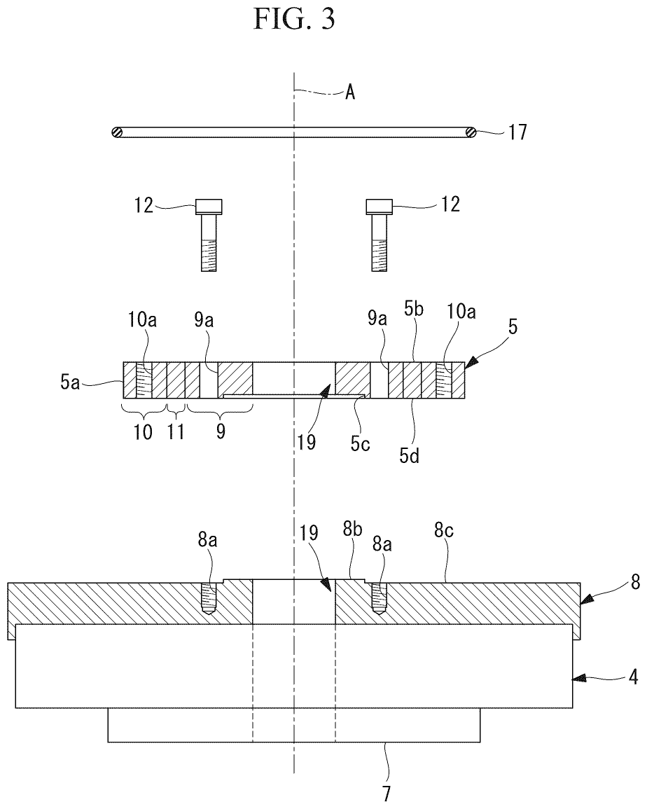

FIG. 3 is an exploded longitudinal cross-sectional view showing a reducer, the torque sensor, and an O-ring of the robot of FIG. 1.

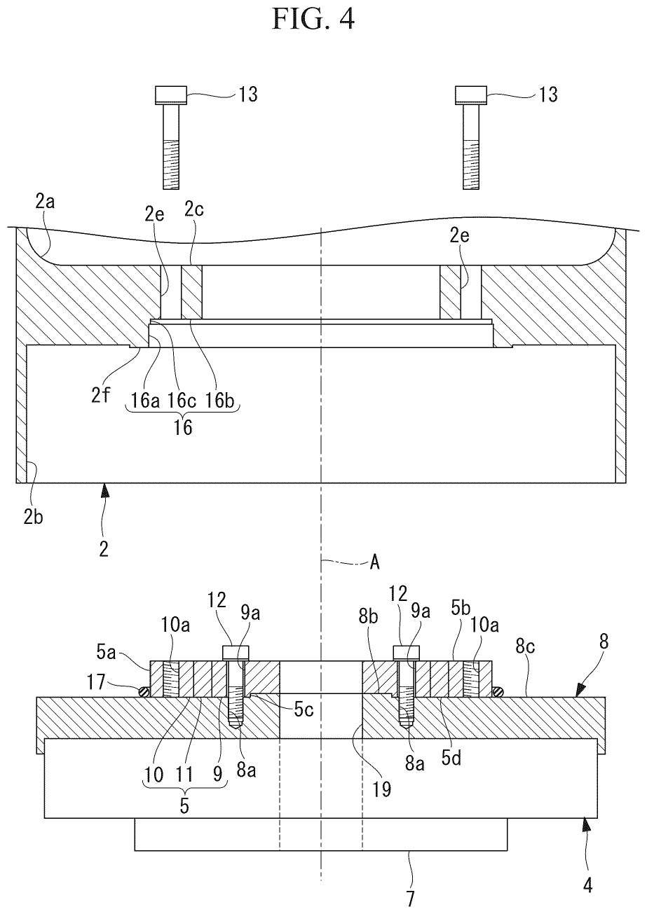

FIG. 4 is an exploded longitudinal cross-sectional view showing an assembly of the reducer, the torque sensor, and the O-ring of FIG. 3 and a first member.

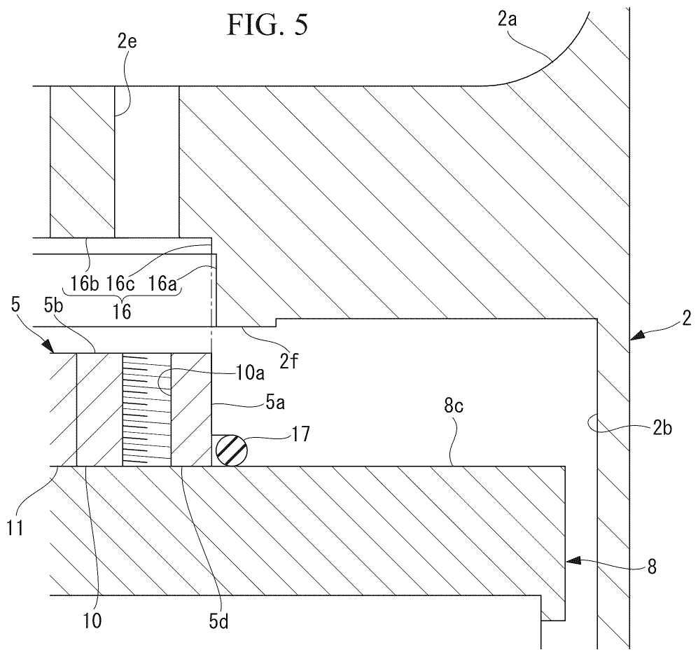

FIG. 5 is an enlarged longitudinal cross-sectional view partially explaining an assembly of the reducer, the torque sensor, and the first member in the seal structure of the torque sensor of FIG. 2.

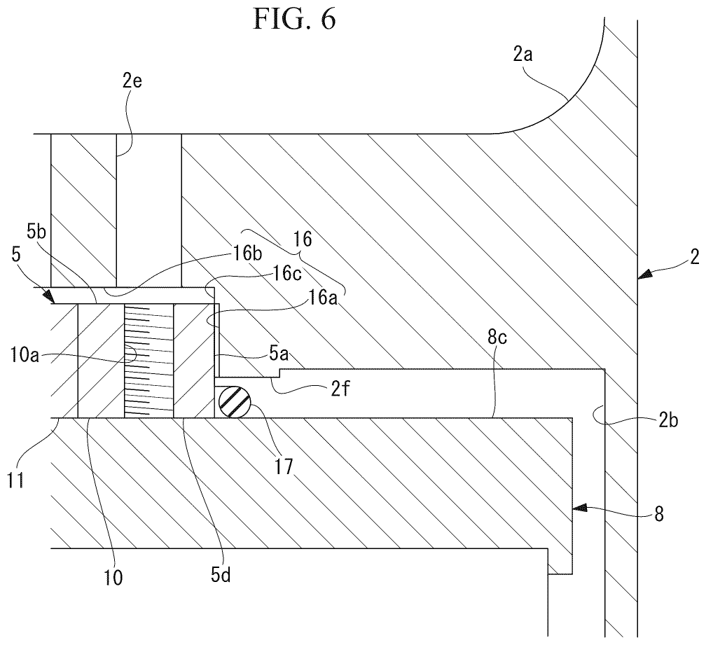

FIG. 6 is an enlarged longitudinal cross-sectional view partially showing a state in which a spigot portion of the first member of FIG. 5 is started to be fitted into the torque sensor.

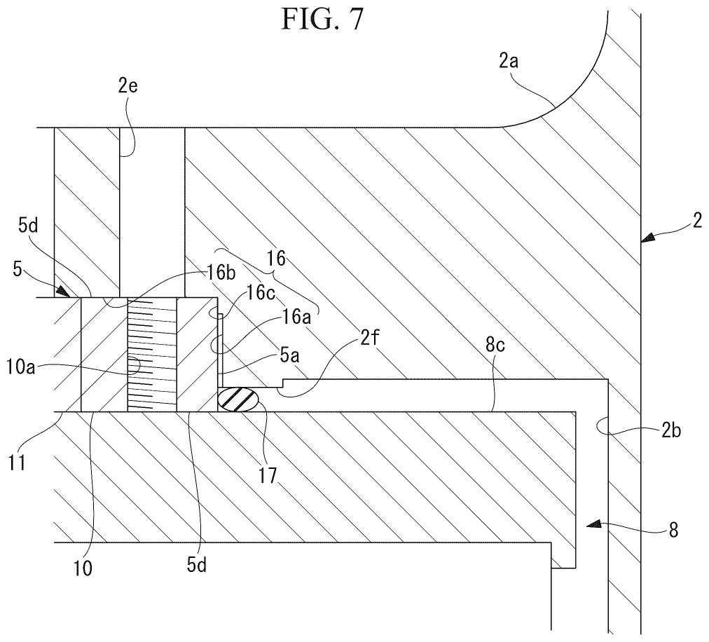

FIG. 7 is an enlarged longitudinal cross-sectional view partially showing a state in which the fitting of the spigot portion and the torque sensor of FIG. 5 is completed.

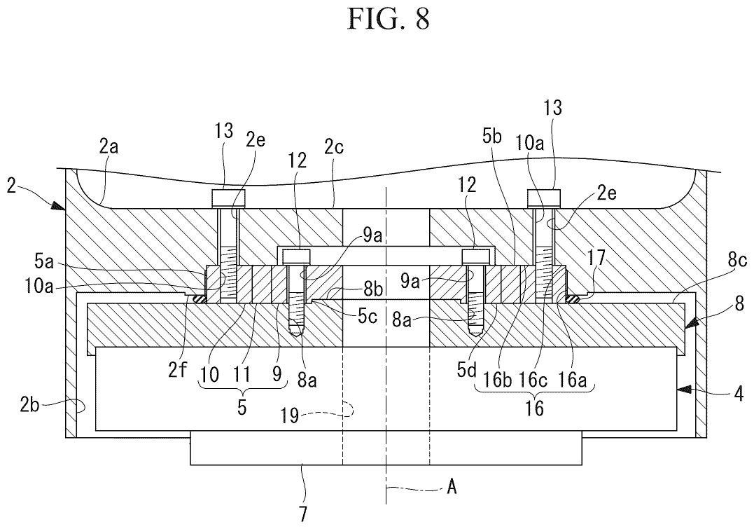

FIG. 8 is a longitudinal cross-sectional view showing a state in which the assembly of FIG. 4 and the first member are assembled.

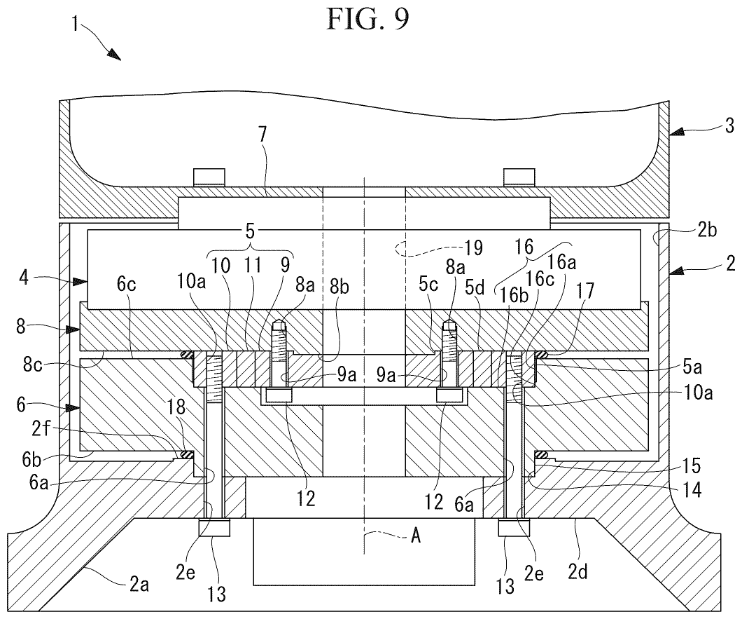

FIG. 9 is a longitudinal cross-sectional view partially showing a robot according to a second embodiment of the present disclosure.

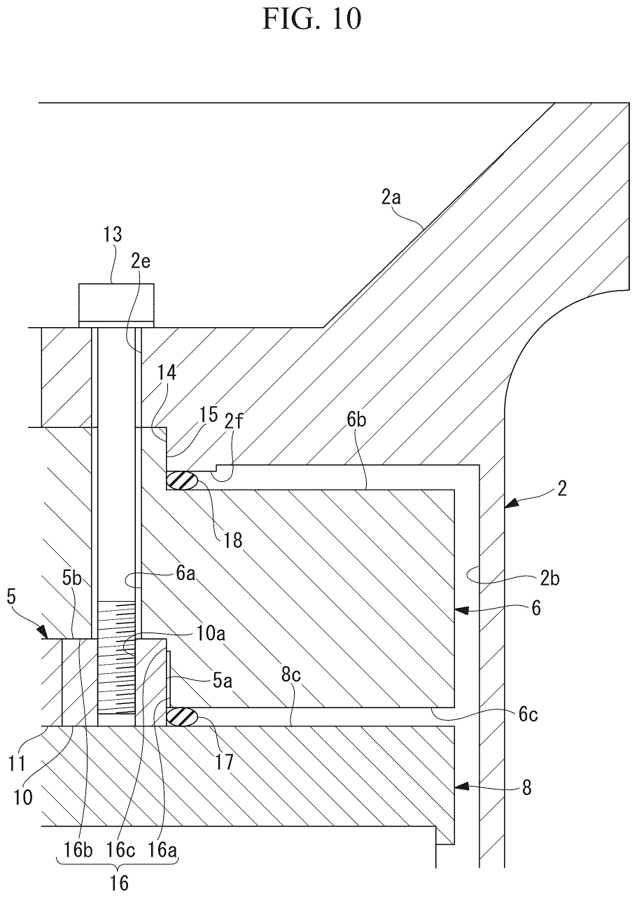

FIG. 10 is an enlarged longitudinal cross-sectional view partially explaining the seal structure of the torque sensor in the robot of FIG. 9.

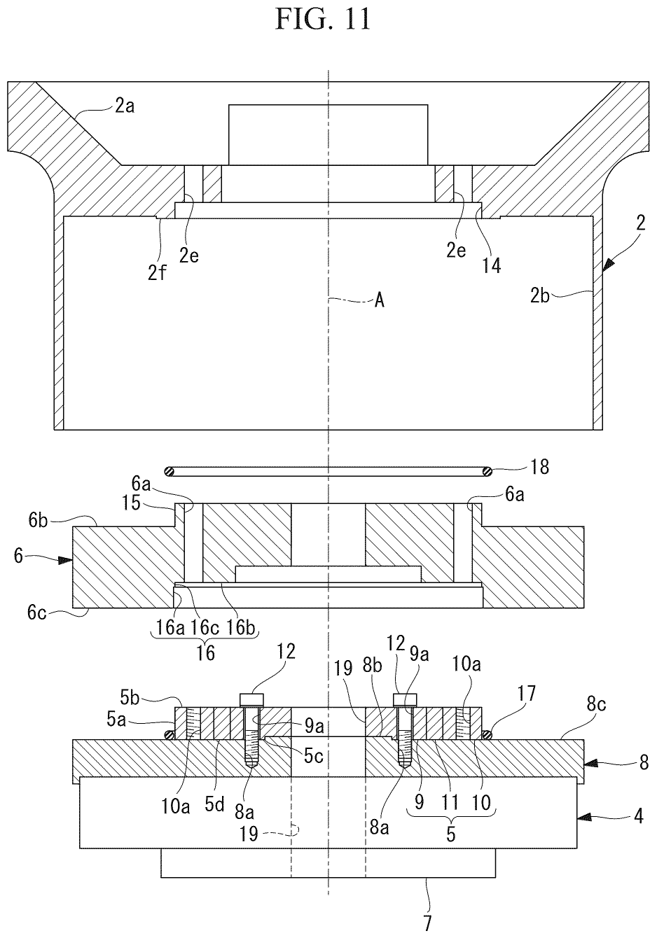

FIG. 11 is an exploded longitudinal cross-sectional view showing the assembly of the reducer, the torque sensor and the O-ring, the adapter, the O-ring, and the base of the robot of FIG. 9.

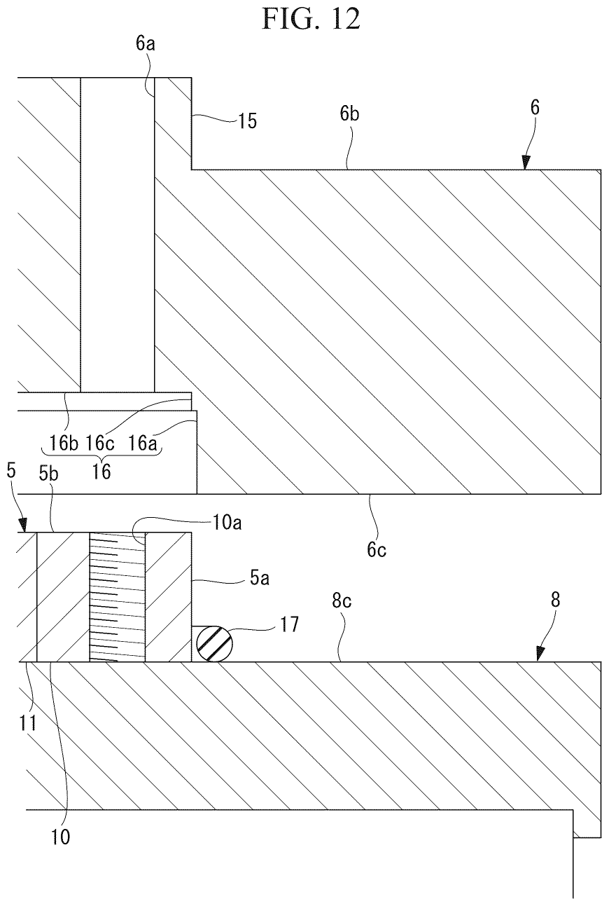

FIG. 12 is an enlarged longitudinal cross-sectional view partially explaining the assembly of the torque sensor and the adapter in the seal structure of the torque sensor of FIG. 10.

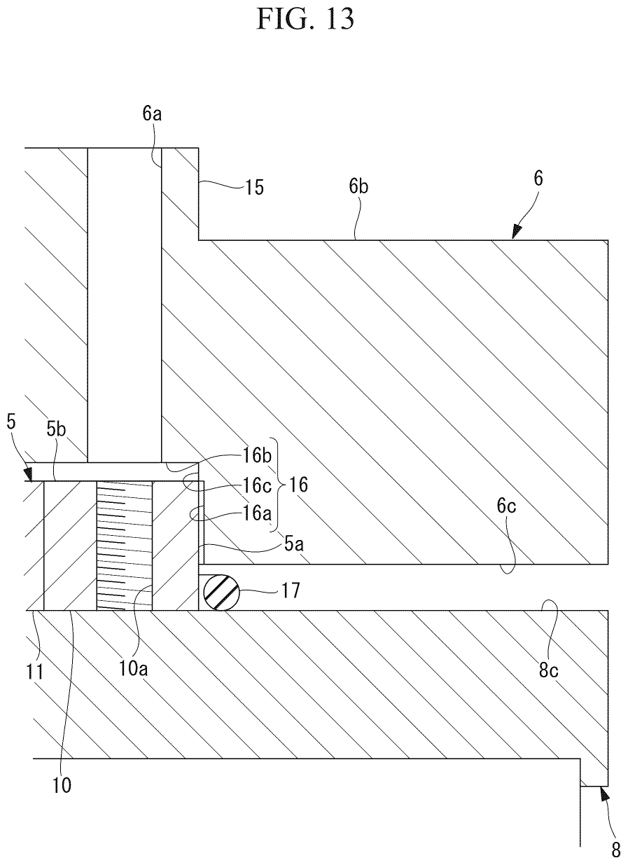

FIG. 13 is an enlarged longitudinal cross-sectional view partially showing a state in which the spigot portion of the adapter of FIG. 12 is started to be fitted into the torque sensor.

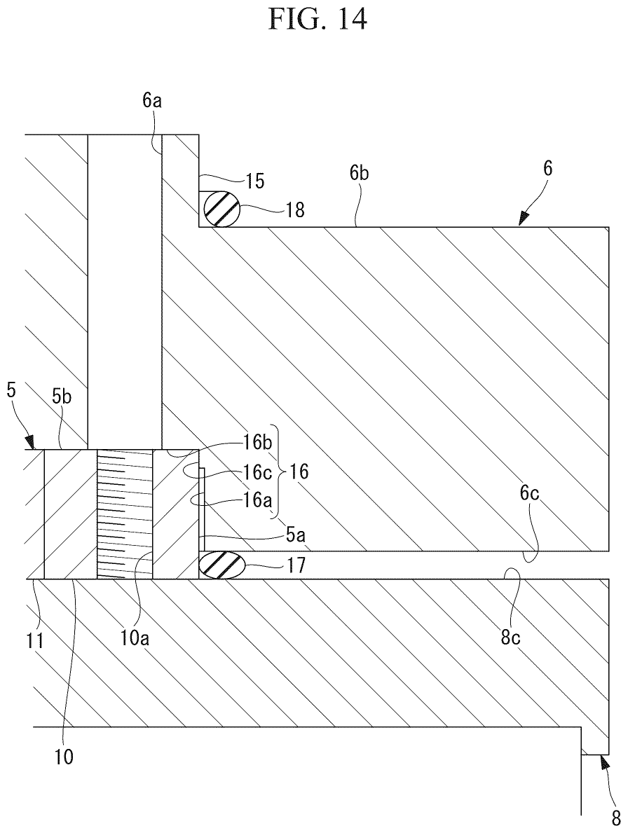

FIG. 14 is an enlarged longitudinal cross-sectional view partially showing a state in which the fitting of the spigot portion of the adapter and the torque sensor of FIG. 12 is completed.

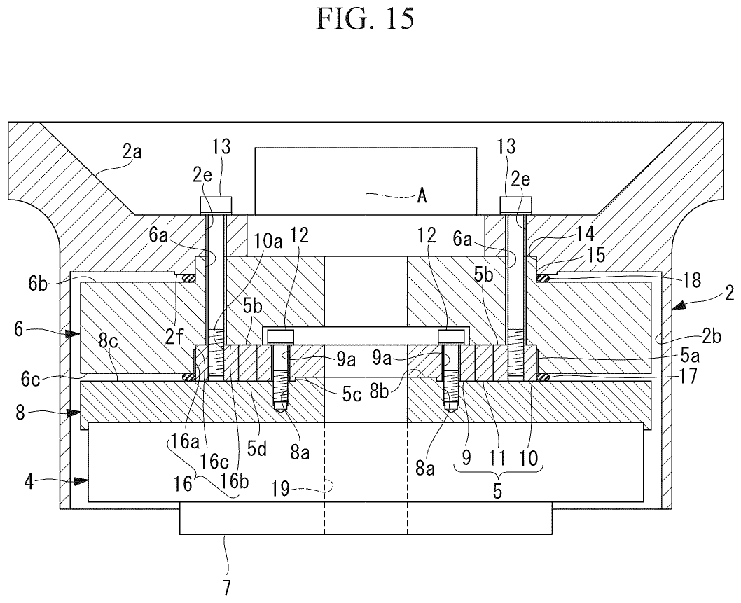

FIG. 15 is a longitudinal cross-sectional view showing a state in which the assembly, the adapter, the O-ring, and the base of FIG. 11 are assembled.

### DESCRIPTION OF EMBODIMENTS

There is a seal structure for a torque sensor and a robot in which one of the cases and the other case are relatively rotated around an axis line of the reducer. For that reason, seal friction which occurs between the two cases affects the torque sensor and decreases detection accuracy of the torque sensor, which is a disadvantage. Accordingly, it is desired to seal the torque sensor without decreasing the detection accuracy.

A seal structure for a torque sensor 5 and a robot 1 according to a first embodiment of the present disclosure will be described with reference to the drawings.

The robot 1 according to this embodiment is a vertically articulated robot, for example. As shown in FIG. 1, a joint of the robot 1 includes a first member 2 and a second member 3 which is supported so as to be rotatable around a first axis line (an axis line) A with respect to the first member 2.

The first member 2 has a cylindrical shape with openings 2a, 2b at both sides in the direction of the first axis line A. The first member 2 has a partition wall 2c that divides an interior space in a direction along the first axis line A. A reducer 4 that rotationally drives the second member 3 around the first axis line A with respect to the first member 2 is arranged at a position between the first member 2 and the second member 3.

Also, a torque sensor 5 is fixed to a position between the reducer 4 and the first member 2. The torque sensor 5 detects a torque around the first axis line A.

The reducer 4 is formed in a cylindrical shape and includes a case (a fixed portion) 8 and an output portion (a movable portion) 7 rotatably supported around the first axis line A with respect to the case 8. The torque sensor 5 is fixed to a position between the case 8 of the reducer 4 and the partition wall 2c of the first member 2.

The torque sensor 5 is formed in a disk shape having a smaller outer diameter than the reducer 4. The torque sensor 5 has a ring shape first portion 9 located at an inside position in the radial direction and a ring shape second portion 10 located at an outside position in the radial direction. Also, the torque sensor 5 has a third portion 11 for connecting the first portion 9 and the second portion 10.

The third portion 11 has a sensor such as a strain gauge or the like, which is not shown, for detecting the torque in response to distortion. The sensor may be placed at a position closer to one of the first portion 9 and the second portion 10, or at a position equally distant from the first and second portions 9, 10.

In the first portion 9 of the torque sensor 5, a plurality of through holes 9a passing through the first portion 9 in the plate thickness direction are provided at intervals in a circumferential direction around the first axis line A. Also, the torque sensor 5 has a circular shape recess 5c centered on the first axis line A in one end surface 5d of the first portion 9.

On the other hand, the case 8 of the reducer 4 includes a protrusion 8b that fits into the recess 5c of the torque sensor 5 and an end surface 8c with which the end surface 5d of the torque sensor 5 is brought into close contact. The protrusion 8b of the case 8 and the recess 5c of the torque sensor 5 are fitted into each other with an extremely short fitting length of 1 to 2 mm, for example.

In a state in which the protrusion 8b is fitted into the recess 5c and the end surface 8c has close contact with the end surface 5d, bolts 12 passing through the through holes 9a are screwed into screw holes 8a. As a result, the torque sensor 5 is fixed to the reducer 4. Also, in the second portion 10 of the torque sensor 5, a plurality of screw holes 10a passing through the second portion 10 of the torque sensor 5 in the plate thickness direction are provided at intervals in a circumferential direction around the first axis line A.

The first member 2 includes a fitting portion 16 which is composed of a circular recess for fitting an outer circumference surface 5a of the torque sensor 5. As shown in FIG. 2, the fitting portion (recess) 16 has an inner circumference surface 16a which is arranged with a space at a radial outside of the outer circumference surface 5a of the torque sensor 5. Also, the fitting portion 16 has a bottom surface 16b against which the end surface 5b in the thickness direction of the second portion 10 of the torque sensor 5 abuts.

The fitting portion 16 includes a spigot portion 16c into which one end portion of the outer circumference surface 15a is fitted when the end surface 5b of the torque sensor 5 abuts against the bottom surface 16b. The fitting length of the spigot portion 16c is set to be slightly larger than an adequate compression margin (a compression amount) of a later-described O-ring 17, however, it is preferable to be as short as possible. For example, when the adequate compression margin of the O-ring is 0.7 mm, the preferable fitting length of the spigot portion 16c is larger than 0.7 mm and smaller than 2 mm.

Moreover, the first member 2 is provided with a plurality of through holes 2e that are open in the bottom surface 16b of the fitting portion 16 with an interval in a circumferential direction around the first axis line A. The through holes 2e are arranged at positions corresponding to the screw holes 10a when fitting the outer circumference surface 5a of the torque sensor 5 into the fitting portion 16.

The bolts 13 passing through the through holes 2e of the first member 2 are screwed into the screw holes 10a of the torque sensor 5. As a result, the torque sensor 5 is fixed to the first member 2 by means of the bolts 13.

As shown in FIG. 2, the first member 2 has an end surface (a plan surface) 2f extending in a direction orthogonal to the first axis line A, and the end surface 2f is located outside in the radial direction relative to the torque sensor 5.

Also, the end surface (plan surface) 8c of the case 8 faces the end surface 2f of the first member 2 with a space in the direction of the first axis line A.

An O-ring (a seal member) 17 is disposed at a position between the end surface 2f of the first member 2 and the end surface 8c of the case 8. The space between the end surface 2f of the first member 2 and the end surface 8c of the case 8 has a dimension that can compress the O-ring 17 by the adequate compression margin.

The compression margin is a difference between wire diameter of the O-ring 17 in the direction of the first axis line A when the O-ring 17 is not compressed and when it is compressed. The O-ring 17 can seal the space so as not to pass liquid and gas by compressing the O-ring 17 by the adequate compression margin.

The O-ring 17 is formed in an annular shape surrounding the torque sensor 5, for example, as shown in FIG. 4, the O-ring 17 in the uncompressed state has an inner diameter that is equal to or larger than the outer diameter of the outer circumference surface 5a of the torque sensor 5. As shown in FIG. 2, the O-ring 17 in the compressed state has the inner diameter such that the O-ring 17 does not come into contact with or come into slight contact with the outer circumference surface 5a of the torque sensor 5.

As a result, the O-ring 17 is arranged at an edge portion (an opening edge portion) surrounding the fitting portion 16. And, the O-ring 17 seals the space at a position between the end surfaces 2f, 8c that come into contact with the O-ring 17 from the both sides in the direction of the first axis line A.

The first member 2, the torque sensor 5, and the reducer 4 have a hollow hole 19 communicating from the first member 2 to an inside of a turning drum 3 in a space including the first axis line A. A wire body (not shown) introduced from one side of the partition wall 2c of the first member 2 can be wired to the side of the second member 3 via the hollow hole 19.

The seal structure of the torque sensor 5 whose structure is described above and the operation of the robot 1 according to the present embodiment will be described below.

The robot 1 according to the present embodiment is assembled as follows.

First, as shown in FIG. 3, the reducer 4 is arranged so that the first axis line A extends in the vertical direction in a state in which the case 8 is arranged so as to face upward. And, the torque sensor 5 is brought closer to reducer 4 from above. The protrusion 8b of the case 8 is fitted into the recess 5c of the torque sensor 5, and the end surface 5d of the torque sensor 5 is brought into close contact with the end surface 8c of the case 8.

In this state, the phase of the through holes 9a of the first portion 9 of the torque sensor 5 and that of the screw holes 8s of the case 8 are aligned with each other. And, as shown in FIG. 4, the bolts 12 passing through the through holes 9a of the first portion 9 of the torque sensor 5 are screwed into the screw holes 8a. As a result, the torque sensor 5 is fixed to the case 8 of the reducer 4 so that they are mutually positioned in the direction of the first axis line A and in the direction orthogonal to the first axis line A.

Subsequently, the O-ring 17 is placed around the outer periphery of the torque sensor 5 fixed on the reducer 4 and is located on the end surface 8c of the case 8 at the radial outside of the outer circumference surface 5a. In this state, as shown in FIG. 4, the first member 2 is lowered from above the torque sensor 5.

As shown in FIG. 5, the torque sensor 5 is inserted into the fitting portion 16 of the first member 2. And, as shown in FIG. 6, the outer circumference surface 5a of the torque sensor 5 is fitted into the spigot portion 16c located in the vicinity of the bottom surface 16b of the fitting portion 16.

In this case, according to the present embodiment, the fitting length of the torque sensor 5 fitted into the spigot portion 16c is set to be slightly larger than the adequate compression margin of the O-ring. Accordingly, as shown in FIG. 6, the fitting of the torque sensor 5 into the spigot portion 16c is started before the first member 2 is brought into contact with the O-ring 17.

When the fitting starts after the first member 2 comes into contact with the O-ring 17, an operator cannot recognize the start of the fitting by the sense of touch, which decreases workability of the assembly work. On the contrary, the operator can recognize the start of the fitting more certainly when the first member 2 is brought into contact with the O-ring 17 after the start of the fitting. Accordingly, the workability of the assembly work will be improved.

Also, as shown in FIG. 7, the outer circumference surface 5a of the torque sensor 5 is fitted into the spigot portion 16c. By bringing the bottom surface 16b of the fitting portion 16 of the first member 2 into contact with the end surface 5b of the torque sensor 5, the O-ring 17 can be compressed by the adequate compression margin.

In this state, the phase of the through holes 6a of the first member 2 and that of the screw holes 10a of the torque sensor 5 are aligned with each other. And, as shown in FIG. 8, the bolts 13 passing though the through holes 2e of the first member 2 are screwed into the screw holes 10a of the torque sensor 5.

By screwing the bolts 13, the torque sensor 5 is fixed to the first member 2. And, the torque sensor 5 and the first member 2 are mutually fixed so as to be in the positioning state in the direction of the first axis line A and in the direction orthogonal to the first axis line A.

Once the bolts 13 are screwed, the space between the case 8 and the first member 2 is equal to the dimension of the O-ring 17 compressed by the adequate compression margin. As a result, the entire periphery of the space between the case 8 and the first member 2 is sealed by the O-ring 17 at the radial outside of the torque sensor 5.

According to the present embodiment, the fitting of the outer circumference surface 5a of the torque sensor 5 and the first member 2 can be achieved by the spigot portion 16c having the sufficiently short fitting length. By fitting the outer circumference surface 5a of the torque sensor 5 into the spigot portion 16c, the center of the torque sensor 5 can accurately be aligned with the center of the first member 2.

Also, reducing the fitting length of the spigot portion 16c can prevent force or a moment from acting on the outer circumference surface 5a of the torque sensor 5 from the side of the first member 2. That is, this can prevent the torque sensor 5 from detecting the force or the moment acts on the outer circumference surface 5a of the torque sensor 5 as the torque. As a result, it can prevent the accuracy of the torque detection of the torque sensor 5 from being decreased.

Further, at the position located outside in the radial direction relative to the torque sensor 5, the space between the case 8 of the reducer 4 and the first member 2 is sealed by the O-ring 17. This can prevent liquid that enters from the outside via the space between the first member 2 and the second member 3 from entering into the side of the torque sensor 5.

As a method for preventing the liquid that enters via the space between the first member 2 and the second member 3 from entering, there may be a method of sealing a cylindrical space between the reducer 4 and the first member 2. However, in this case, the sliding resistance of the O-ring compressed at the position between the reducer 4 and the base 2 acts during the operation for fitting the torque sensor 5 into the first For that reason, the operator cannot recognize the start of the fitting by the sense of touch. Further, if the bolts 13 are screwed in a state where the fitting is not properly performed, there is a disadvantage that the assembly is performed in a state where the fitting surface is damaged or the fitting surface is inclined.

According to the present embodiment, the O-ring 17 is compressed at a position between the end surfaces 2f, 8c orthogonal to the first axis line A. As a result, the slide resistance of the O-ring 17 does not act during the operation for fitting the outer circumference surface 5a of the torque sensor 5 into the recess 14 of the first member 2. Accordingly, the operator can easily recognize the start of the fitting by the sense of touch and suitably perform the assembly.

Also, in the present embodiment, the O-ring 17 arranged at the position between the case 8 and the first member 2 is compressed at the position located radially outside of the torque sensor 5. And, the compressed O-ring 17 does not touch or only touches slightly the outer circumference surface 5a of the torque sensor 5.

Accordingly, the torque sensor 5 is not affected by the force or the moment via the O-ring 17. This prevents the torque sensor 5 from detecting the force or the moment acted on the torque sensor 5 through the O-ring 17 as a torque.

Also, the present embodiment shows a vertically articulated robot as the robot 1. Instead of this, any type of robot as the robot 1 can be applied.

Further, this embodiment shows the seal structure of the torque sensor 5 which is provided at a position between the first member 2 and the second member 3.

A turning drum can be adopted as the first member 2, for example, and a first arm can be adopted as the second member 3. Alternatively, the similar configuration can be adopted as the seal structure of the torque sensor arranged at the position between a reducer of another joint axis and a first member 2.

Further, the O-ring 17 is adopted as the seal member, however, instead of this, any seal member such as a ring shape gasket and the like may be adopted.

Also, the present embodiment roughly guides the radial directional position of the O-ring 17 using the outer circumference surface 5a of the torque sensor 5. Alternatively, an O-ring groove may be formed in the case 8 or the first member 2 so as to define a radial directional position of the O-ring 17.

According to the present disclosure, the torque sensor 5 can accurately detect the torque acts on the first member 2 from the reducer 4, which is advantageous. Also, with the robot 1 according to the present disclosure, it is possible to conduct a force control by using the seal structure of the torque sensor 5 that can detect the torque accurately.

Subsequently, a seal structure of a torque sensor 5 and a robot 1 according to a second embodiment of the present disclosure will be described with reference to the drawings.

In the description of the present embodiment, the same reference symbols are given to the common components as those of the first embodiment described above, and their description will be omitted.

The first embodiment exemplifies the case in which the torque sensor 5 is directly fixed to the first member 2. Alternatively, this embodiment describes a case in which the torque sensor 5 is fixed to the first member 2 using an adopter 6 in-between, as shown in FIG. 9. In the present embodiment, the first member 2 is a base and the second member 3 is a turning drum. Hereinafter they may be referred to as the base 2 and the turning drum 3 as well.

It is preferable that the adapter 6 is formed to be in a disk shape radially larger in the outside than the torque sensor 5 using a material having a higher rigidity than the material composing the base 2. In such a case in which the base 2 is made of aluminum alloy or the like, the adapter 6 is preferably made of iron or the like.

Also, the adapter 6 is provided with the plurality of through holes 6a passing through it in the plate thickness direction with an interval in the circumferential direction.

The adapter 6 is fixed to the torque sensor 5 by screwing the bolts 13 passing the through holes 6a into the screw holes 10a of the second portion 10.

Also, the adapter 6 has a sufficiently larger outer diameter than the outer diameter of the torque sensor 5. That is, the adapter 6 further extends outward in the radial direction beyond the outer circumference surface 5a of the torque sensor 5. In the example shown in FIG. 9, the outer diameter of the adapter 6 is the same as or similar to the outer diameter of the reducer 4.

Further, the adapter 6 is large enough to cover the entire radial area of the torque sensor 5.

In other words, the adapter 6 has such a size that extends to a radial inside of the second portion 10 of the torque sensor 5, which is necessary for fixation. Also, the adapter 6 has a thickness dimension sufficiently larger than the thickness of the torques sensor 5. As a result, the adapter 6 maintains the enough rigidity for suppressing deformation of the first member 2.

The adapter 6 has a first fitting portion 15 composed of a circular protrusion which fits into a circular recess 14 provided in the first member 2 centering the first axis line A. In the present embodiment, a fitting portion (referred to as a second fitting portion) 16 is provided in the adapter 6. An outer diameter of the protrusion the first fitting portion 15 and an inner diameter of the recess composing the second fitting portion 16 are set to be approximately the same.

Also, the through holes 6a are provided at the positions corresponding to the screw holes 10a when fitting the outer circumference surface 5a of the torque sensor 5 into the second fitting portion 16.

Also, the through holes 2e of the base 2 is provided at the positions corresponding to the through holes 6a when fitting the first fitting portion 15 of the adapter 6 into the recess 14.

The bolts 13 passing through the through holes 2e of the base 2 and the through holes 6a of the adapter 6 are screwed into the screw holes 10a of the torque sensor 5. As a result, the torque sensor 5 and the adapter 6 can be fixed together to the base 2 by screwing the bolts 13.

An outer portion of the adapter 6 located outside in the radial direction than the torque sensor 5 has parallel end surfaces (plan surfaces) 6b, 6c orthogonal to the thickness direction at both sides in the thickness direction. As shown in FIG. 10, an end surface 2f of the base 2 faces the end surface 6b of the adapter 6 with a space in the direction of the first axis line A. Also, an end surface 8c of the case 8 of the reducer 4 faces the end surface 6c of the adapter 6 with a space in the direction of the first axis line A.

The O-ring (a second seal member) 18 is formed in an annular shape surrounding the first fitting portion 15 and is placed at a position located between the end surface 2f of the base 2 and the end surface 6b of the adapter 6. Also, the O-ring 17 is placed at a position located between the end surface 8c of the case 8 of the reducer 4 and the end surface 6c of the adapter 6.

A space between the end surface 2f of the base 2 and the end surface 6b of the adapter 6 has a dimension capable of compressing the O-ring 18 by the adequate compression margin. Also, the space between a plan surface 8c of the case 8 and a plan surface 6c of the adapter 6 has a diameter capable of compressing the O-ring 17 by the adequate compression margin.

The O-rings 17, 18 seal the space so as not to pass the liquid and gas from passing through the space by being compressed by the adequate compression margin.

The O-ring 17 seals the space at a position located between the plan surfaces 6c, 8c contacting the O-ring 17 from the both sides in the direction of the first axis line A. The O-ring 18 seals the space by compressing the O-ring 18 in the direction of the axis line A at a position between the end surfaces 2f, 6b contacting the O-ring 18 from the both sides in the direction of the first axis line A.

The adapter 6 also has a hollow hole 19 that communicates to an inside of the turning drum 3 from the base 2 in the space including the first axis line A.

The seal structure of the torque sensor 5 and an operation of the robot 1 according to the present embodiment configured as described above will be described below.

The robot 1 according to the present embodiment will be assembled as described below.

First, the reducer 4, the torque sensor 5, and the O-ring 17 are assembled in the similar way as in the first embodiment.

With the assembly up to the O-ring 17 complete, the adapter 6 is lowered from above the torque sensor 5, as shown in FIG. 11. As shown in FIG. 12, the torque sensor 5 is inserted into the second fitting portion 16 of the adapter 6. And, as shown in FIG. 13, the outer circumference surface 5a of the torque sensor 5 is fitted into the spigot portion 16c located in the vicinity of the bottom surface 16b of the second fitting portion 16.

In this embodiment as well, the fitting length of the torque sensor 5 fitted into the spigot portion 16c is set to be slightly larger than the adequate compression margin of the O-ring 17. Accordingly, as shown in FIG. 13, the fitting of the torque sensor 5 into the spigot portion 16c starts before the adopter 6 comes into contact with the O-ring 17.

The adapter 6 is brought into contact with the O-ring 17 after the fitting is started so that the operator can reliably recognize the start of the fitting, which improves the workability of the assembly work.

And, as shown in FIG. 14, the outer circumference surface 5a of the torque sensor 5 is fitted into the spigot portion 16c. By bringing the bottom surface 16b of the second fitting portion 16 of the adapter 6 into close contact with the end surface 5b of the torque sensor 5, the O-ring 17 is compressed by the adequate compression margin. In this state, the phase of the through holes 6a of the adapter 6 and that of the screw holes 10a of the torque sensor 5 are made to align with each other.

Also, in this state, as shown in FIG. 14, the O-ring 18 is arranged at a position on the end surface 6b located outside in the radial direction of the first fitting portion 15 of the adapter 6. And, as shown in FIG. 11, the base 2 is brought closer from above the adapter 6 so as to fit the first fitting portion 15 of the adapter 6 into the recess 14 of the base 2.

At the point when the bottom surface of the recess 14 of the base 2 comes into close contact with the end surface of the adapter 6, the phase of the through holes 2e of the base 2 and that of the through holes 6a of the adapter 6 are made to align with each other. And, as shown in FIG. 15, the bolts 13 passing through the through holes 2e, 6a of the base 2 and the adapter 6 are screwed into the screw holes 10a of the torque sensor 5.

By screwing the bolts 13, the torque sensor 5 and the adapter 6 are fixed to the base 2 by co-fastening. And, the torque sensor 5, the adapter 6, and the base 2 are fixed so that they are mutually positioned in the direction of the first axis line A and in the direction orthogonal to the first axis line A.

Fixing by co-fastening the bolts 13 allows the torque sensor 5 and the adapter 6, and the adapter 6 and the base 2 to be fixed at the same distance in the radial direction. Compared to the case in which the fixed distance is different in the radial direction, the torque sensor 5 is less likely to be affected by moments generated around an axis orthogonal to the first axis line A.

Further, as a result of the co-fastening, it is not necessary to provide a counter bore of the adapter 6, which is required when fixing the adapter 6 to the torque sensor 5 and the base 2 separately. This can prevent the rigidity of the adapter 6 from being decreased and the adapter 6 from becoming larger than necessary.

Once the co-fastening is completed, the space between the case 8 and the adapter 6, and between the base 2 and the adapter 6 can be equal to the diameter of the O-rings 17, 18 being compressed by the adequate compression margin. As a result, the O-ring 17 seals the entire periphery of the space between the case 8 of the reducer 4 and the adapter 6 at a position located outside in the radial direction of the torque sensor 5. Moreover, the O-ring 18 can also seal the entire periphery of the space between the base 2 and the adapter 6 at a position located outside in the radial direction of the first fitting portion 15 of the adapter 6.

Accordingly, according to the present embodiment, the torque sensor 5 is fixed to the base 2 using the adapter 6. Also, the adapter 6 is made of a material having the higher rigidity than the base 2. Further, the adapter 6 has a form that extends not only toward the second portion 10 of the torque sensor 5, which is thick and fixed, but widely toward the outside in the radial direction of the second portion 10.

As a result, the adapter 6 has sufficiently high rigidity and to sufficiently suppress the deformation of the base 2 at the bottom surface of the recess 14 to which the adapter 6 is fixed. That is, the adapter 6 can suppress the deformation of the base 2 caused by the force or the torque applied to the torque sensor 5 from the side of the reducer 4, which improves the detection accuracy of the torque sensor 5.

Also, according to the present embodiment, the fitting of the outer circumference surface 5a of the torque sensor 5 and the adapter 6 is achieved by the spigot portion 16c having a sufficiently small fitting length. By fitting the outer circumference surface 5a of the torque sensor 5 into the spigot portion 16c, the center of the torque sensor 5 and that of the adapter 6 can be aligned with high accuracy.

Also, reducing the fitting length of the spigot portion 16c can prevent the force or the moment from acting on the outer circumference surface 5a of the torque sensor 5 from the adapter 6 side. That is, the force or the moment acting on the outer circumference surface 5a of the torque sensor 5 can be prevented from being detected as torque by the torque sensor 5. Accordingly, this can prevent decrease in the accuracy of torque detection by the torque sensor 5.

Further, the space between the case 8 of the reducer 4 and the adapter 6 is sealed by the O-ring 17 at the radial outside of the torque sensor 5. As a result, the liquid that enters from the outside via the space between the base 2 and the turning drum 3 can be prevented from entering into the torque sensor 5 side.

Further, the space between the adapter 6 and the base 2 is also sealed by the O-ring 18. This prevents the liquid that enters from the outside via the space between the base 2 and the turning drum 3 from entering into the radial inside of the adapter 6.

Another method to prevent liquid from entering via the space between the base 2 and the turning drum 3 is to seal the cylindrical space between the reducer 4 and the base 2. According to this method, only one O-ring used is sufficient.

However, in this case, the sliding resistance of the compressed O-ring acts between the reducer 4 and the base 2 during the process of fitting the adapter 6 into the base 2. For that reason, there may be a case in which the operator cannot recognize the start of the fitting by the sense of touch. Further, if the bolts 13 are screwed without being fitted appropriately, there is the inconvenience of damage to the fitting surface or being assembled with tilted surfaces.

According to the present embodiment, the O-ring 17 is compressed at a position located between the plan surfaces 6c, 8c orthogonal to the first axis line A. As a result, the sliding resistance of the O-ring 17 does not occur during the operation for fitting the first fitting portion 15 of the adapter 6 into the recess 14 of the base 2. Accordingly, the operator can easily recognize the start of the fitting by the sense of touch and perform the assembly work properly.

Also, in the present embodiment, the O-ring 17 is compressed by compressing it in the direction of the axis line A between the case 8 and the adapter 6 in the radial outside direction of the torque sensor 5. This can prevent the torque sensor 5 from detecting the force or the moment acting on the torque sensor 5 via the O-ring 17 as the torque.

Further, in the present embodiment, the base 2, the adapter 6, and the torque sensor 5 are co-fastened at the equal distance around the first axis line A by screwing them. Alternatively, the base 2 and the adapter 6, and the adapter 6 and the torque sensor 5 can be fixed separately at the equal distance around the first axis line A.

The adapter 6 and the torque sensor 5 can be fixed in advance by separately fixing the base 2 and the adapter 6, and the adapter 6 and the torque sensor 5. This allows the torque sensor 5 and the adapter 6 to be managed as a unit.

Also, the base 2 and the adapter 6 may be fixed at the radial outside of the torque sensor 5. In this case, the size of the bolts 13 can be larger, and the number of the bolts 13 can be reduced.

In addition, the O-rings 17, 18 are employed as the seal member, however, instead of this, any other seal member such as a ring gasket, and the like may be employed.

Also, in the present embodiment, the radial position of the O-rings 17, 18 are roughly guided by the inner outer circumference surface 5a or the first fitting portion 15.

Instead of this, the O-ring groove may be formed in the adapter 6, the case 8, or the base 2 to define the radial position of the O-rings 17, 18.

Further, the adapter 6 which has sufficiently higher rigidity than the base 2, and which can suppress the deformation of the base 2 is shown in the example. Alternatively, when the base 2 is highly rigid, a less rigid adapter may be employed as the adapter 6.

According to the present disclosure, it has an advantage that the reducer 4 can accurately detect the torque acting on the first member 2 even if the first member 2 for fixing the reducer 4 is less rigid.

While the embodiments of the present disclosure have been described in detail, it is not limited to the individual embodiments described above. Various additions, substitutions, modifications, partial deletions, and the like can be made in these embodiments within a range not departing from the gist of the invention, or within a range not departing from the concept and purport of the invention derived from the contents described in the claims and equivalents thereof. For example, in the above-described embodiments, the order of operations, the order of processing, the omission or addition of some operations according to conditions, and the omission or addition of some processing according to conditions can be performed without being limited to the above-described example. Also, the same applies to the case where numerical values or mathematical expressions are used in the description of the above-described embodiments.

1. A seal structure for a torque sensor, the seal structure being fixed to a position between a first member and a fixed portion of a reducer, which includes the fixed portion and a movable portion rotatably supported by the fixed portion around a predetermined axis line,
wherein the torque sensor detects a torque around the axis line,
wherein the seal structure comprises an annular shape seal member surrounding an outer periphery of the torque sensor, and
the seal member is compressed by the fixed portion and the first member in a direction along the axis line.

2. The seal structure for the torque sensor according to claim 1, wherein
the torque sensor is formed in a disk shape,
one of the fixed portion or the first member is provided with a recess having an inner circumference surface arranged at a radially outside position of an outer circumference surface of the torque sensor, and
the seal member is compressed at an opening edge portion of the recess.

3. A seal structure for a torque sensor, the seal structure being fixed to a position between a first member and a fixed portion of a reducer, which includes the fixed portion and a movable portion rotatably supported by the fixed portion around a predetermined axis line,
wherein the torque sensor is fixed to the first member using an adapter and detects a torque around the axis line,
wherein the seal structure comprises an annular shape seal member surrounding an outer periphery of the torque sensor, and
the seal member is compressed by the fixed portion and the adapter in a direction along the axis line.

4. The seal structure for the torque sensor according to claim 3, wherein
the torque sensor is formed in a disk shape,
one of the fixed portion or the adapter is provided with a recess having an inner circumference surface arranged at a radially outside position of an outer circumference surface of the torque sensor, and
the seal member is compressed at an opening edge portion of the recess.

5. The seal structure of the torque sensor according to claim 3 further comprising
an annular shape second seal member,
wherein the second seal member is compressed by the first member and the adapter in the direction along the axis line.

6. A robot comprising:
a first member;
a second member;
a reducer that supports the second member so as to be rotatable around a predetermine axis line with respect to the first member;
a torque sensor fixed to a position between the reducer and the first member, the torque sensor detecting a torque around the axis line; and
an annular shape seal member surrounding an outer periphery of the torque sensor, wherein
the reducer includes a fixed portion to which the torque sensor is fixed and a movable portion which is rotatably supported by the fixed portion around the axis line, and
the seal member is compressed by the fixed portion and the first member in the direction along the axis line.
